(19) United States
(12) Patent Application Publication
(10) Pub. No.: US 2007/0277218 A1
(43) Pub. Date: Nov. 29, 2007

(54) Interactive television system

(75) Inventor: George Rome Borden, Portland, OR (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/440,681

(22) Filed: May 24, 2006

(51) Int. Cl. H04N 7/16; H04N 5/445; G06F 13/00; G06F 3/00

(52) U.S. Cl. 725/135; 725/37; 725/38; 725/52; 725/53

(57) ABSTRACT

The present invention provides a method and system for providing a TV-viewer with interactive television program selections that relate both to the program content of the current selection and a pay-for-placement of program content selections by advertisers/owners of television programs. According to the method, when a TV-viewer initiates a programming choice, a window opens displaying alternative choices to the viewer in an ordered list. The choices may be related to the current choice by content, at least in part, and may be displayed in an order of prominence depending upon amounts bid by advertisers/owners of the TV programming.

### CROSS-REFERENCE TO RELATED APPLICATIONS

Not applicable.

### BACKGROUND OF THE INVENTION

Typically, televisions connect to multiple services at the same time. For example, some televisions have three tuner types embedded: 8VSB, QAM and NTSC. These tuners permit the television to receive digital broadcast, digital cable, analog broadcast and/or analog cable. Currently, no service for television exists that provides a unified method of discovering and finding content across all available services and all types of broadcast mediums. This situation will be aggravated in the future due to the inevitable introduction of bi-directional digital cable television service provided by telecommunication companies and Internet service provides. Televisions will become portals into both the TV-programming world and the Internet. Some television providers currently provide a guide service that displays multiple selections of programming within a time window. Thus, with a click of the “guide” button, a user may view a small inserted screen that displays a selected number of (five or six) programs currently available in grid fashion. Usually, these programs are grouped to be close to the channel that is currently being viewed. For example, if channel four is the TV-viewer's current program selection choice, the guide will likely display, in grid form, the current programming choices on channels five, six, seven and eight (according to the amount of space available on the screen).

The problem with this system is that there are hundreds of available programming choices. Further, it would be advantageous to the viewer if a selected number of programming choices matched by content could be provided to the viewer. For example, if a TV-viewer's program selection is “CSI,” it may be desirable to display to the viewer all programs, either playing or which will commence within a certain time window, having content related to “CSI” such as “Law and Order,” “NCIS,” or other “CSI”-type programs. Similarly, if the programming choice is “Seinfeld,” the display might be configured to display all other “Seinfeld” episodes running at the same time or within a preset time window and also including related television-programming choices such as “Friends” and “Everybody Loves Raymond.”

These programming choices can be based on a search algorithm that is similar in many respects to Internet search algorithms that are used by search engines such as Google® to display content to a user, which suggests selected websites identified by URLs that match the user's search criteria. In addition, this service, which is provided by the Internet search engine, generates revenue for the search engine by way of advertising dollars. Advertisers associate bids with their websites and pay Google® to display their websites more prominently when a match is made with a search query that relates to the content of the advertiser's website. This business model is described in U.S. Pat. No. 6,876,997 to Rorex et al. and in published U.S. application no. US2004/0260689 by Colace et al. According to the systems described in the above patent and published application, a search engine displays search query results in a way that provides prominence to advertisers who bid higher amounts with the website associated with the highest advertiser bid amount having the most prominent display in answer to the search engine query.

Despite the fact that television platforms now include both digital and analog programming content, no system exists which can display multiple programming choices to a viewer that may be similar to the program the viewer has currently selected. Further, no system exists that can generate advertising revenue for the television system provider by allowing the owners of television programming to place bids which would allow their programs to be more prominently displayed in a list of available programming choices.

The PC environment in which the current advertising system exists is distinctly different from the TV environment in two main ways, the TV is viewed from 3˜6 picture heights away, while the PC is viewed at 1˜2 picture heights away. This makes it difficult to display long lists of detailed text, so the amount of information that can be displayed on the TV is very limited. The second item is the PC has a keyboard for text entry. The TV typically has a remote control and users expect a much simpler less “engaged” user experience.

The present embodiments provide a method and system for providing a TV-viewer with interactive television program selections that relate both to the program content of the current selection and a pay-for-placement of program content selections by advertisers/owners of television programs. According to the method, when a TV-viewer initiates a programming choice, a window opens displaying alternative choices to the viewer in an ordered list. The choices may be related to the current choice by content, at least in part, and may be displayed in an order of prominence depending upon amounts bid by advertisers/owners of the TV programming.

The foregoing and other objectives, features, and advantages of the invention will be more readily understood upon consideration of the following detailed description of the invention taken in conjunction with the accompanying drawings.

### BRIEF DESCRIPTION OF THE SEVERAL VIEWS OF THE DRAWINGS

FIG. 1 is a flowchart illustrating the method of operation of a preferred embodiment showing the functions of the various providers.

FIG. 2 is a flowchart diagram illustrating an embodiment of the method for providing interactive television viewing.

FIG. 3 is an illustration of a how the user would view the system in operation.

FIG. 4 is an illustration of an alternative form of a user interface.

### DETAILED DESCRIPTION OF PREFERRED EMBODIMENT

A method of providing a TV-viewer with interactive television program selections includes the steps of compiling a first database set of available TV program selections existing within a predetermined time window and assigning content indicators to the TV programs so that they can be matched or correlated with other programs. A second database is compiled which includes TV program selections for which advertisers have submitted bids. These programs may also be classified according to content by using the same content indicators. Such indicators may include, for example, the genre, featured actors/actresses, subgenre characterizations, and/or ratings.

The system is triggered by the detection of a programming selection choice by the TV-viewer. This may include powering up the television, changing the channel, or selecting a guide function (available on digital TV transmission services). When the system detects the initiation of a programming selection choice, it searches the first database set for matching content determined by some preselected content-indicating parameter. For example, if the selection is a television show involving doctors and hospitals, the database search might generate a number of program alternatives appearing within a predetermined timeslot where there were also hospital dramas. This predetermined timeslot can be contemporaneous with the running time of the program currently selected or it may be television programming that appears later within a preset time window. For example, it could include all medical/hospital programs appearing within a one-hour time window or a two-hour time window past the end of the currently appearing program. Next, the system searches the second database, which contains TV-program selections containing bid amounts submitted by advertisers. These may, or may not, be searched according to content as defined by content indicating parameters, but they are programs airing with the same time window. In some cases, the first and second databases may be physically within the same physical database, but typically different fields of the database.

In one aspect of the invention, programming selections from both the first and second databases are displayed to the TV-viewer in an ordered list of alternative programming selections. Thus, the list may contain selections based upon pure programming content and may contain selections based upon the amount of bids from advertisers. The programming selections supported by bids submitted by advertisers may be displayed more prominently in the ordered list. They may be displayed, for example, at the top of the list, displayed in bold or larger type, or in some other way that gives these selections more prominence.

Once the selections are displayed, any program content selection from the second database may be debited to the advertiser commensurate with its bid amount. In this way, the TV transmission service provider or the database search engine provider generates revenue by selling advertising while at the same providing a service for the TV-viewer who can see, in real time, alternative programming selections.

The first database may actually comprise a database set. This set of separate but related databases could contain information such as: user information solicited periodically or at the startup of service; a history of the user's programming selection choices; if the television transmission service provides such a feature, user settings could provide preferred types of programming selections; and finally, a database subset could exist consisting of television program selections based upon peer recommendations.

In the environment of television based video content all (or most of) of the potential content that is available or going to be available is generally known or defined within certain broad categories, unlike traditional web search engine queries which may include nearly anything. Based upon this knowledge the first database may be relatively specific and include only that data which is related to an anticipated search, and hence the database may be relatively compact. Similarly, the second database of advertisers, which are related to the anticipated content, may likewise be relatively well defined due to the limited anticipated search space. The resulting data provided to the user based upon the first and second database, may be arranged in any suitable manner. One type of presentation is in the form of a list. In this manner, the system may only need to search the local database(s) to obtain the necessary information for presentation. For example, the greater the money the advertiser is willing to pay may result in that advertiser being listed higher or more prominently in the search results.

Thus, the display to the viewer, which may occur in a sized window on the television screen, may consist of a mix of pure recommendations based solely upon content and recommendations paid for by advertisers. Whenever an advertiser's program is displayed in this list, the advertiser receives a debit equal to the amount of the bid. The advertiser recommendations may or may not be content related to the initial program selection choice by the television viewer or it may be related to that program selection in a more general way at a more global level of relevance. For example, if the recommendations from the first database are related to the viewer's initial selection by genre and subgenre, the selection from the second database might only with in the first level genre.

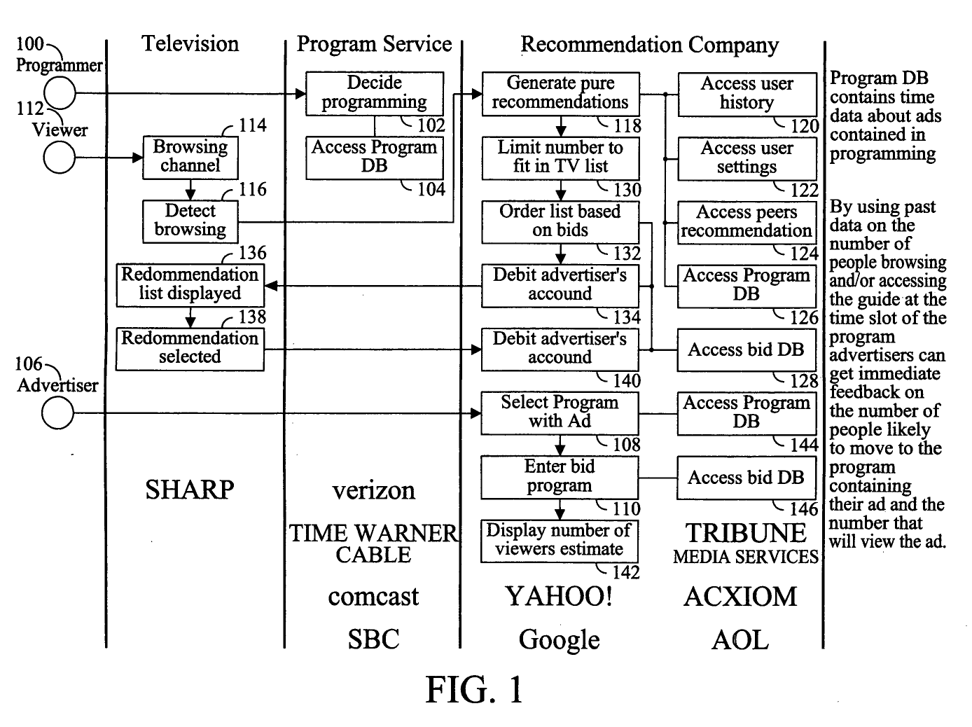

Referring to FIG. 1, a flowchart illustrates in graphical form the way the method is carried out. The columns of FIG. 1 display the functions of the method performed by the TV itself, the TV broadcaster (program service) and the database search engine provider (the Recommendation Company). A programmer 100 decides to provide programming (block 102) which is placed in a database 104. An advertiser 106 selects a program and places advertising in the program at block 108. At block 110, the advertiser enters a bid for that program. A television viewer 112 browses television channels (block 114) and such browsing is detected by the system (block 116). The recommendation company who provides the database system searches its database and generates pure recommendations (block 118). These pure recommendations are based upon a search of the overall program database and may include a search of user history (block 120), user settings (block 122), and/or peer recommendations (block 124). The general program database (block 126) is searched for related content as defined by one or more program-content indicators. At the same time, the bid database is accessed (block 128). The number of recommendations are limited (block 130) so that they fit within the window that provides the display space on the television. Based upon the results of the access-bid database search, an ordered list is displayed to the TV-viewer (block 132) in which the higher bid items are displayed more prominently, for example, at the top of the list. Having displayed the program selection choices in positions of prominence based upon the search of the bid database, an advertiser's account is debited (block 134). The recommendation list is then displayed on the viewer's television (block 136). If the TV-viewer selects one of the recommendations from the access bid database (block 138), the advertiser's account is debited again (block 140).

According to other features, the recommendation company, which performs the search and maintains the databases, may display the number of estimated viewers to the advertiser (block 142). This enables the advertiser 106 to select appropriate bids. The advertisers do so by accessing the program database (block 144) by placing programs in this database which contain their advertising and by accessing the bid database (block 146) to enter appropriate bids.

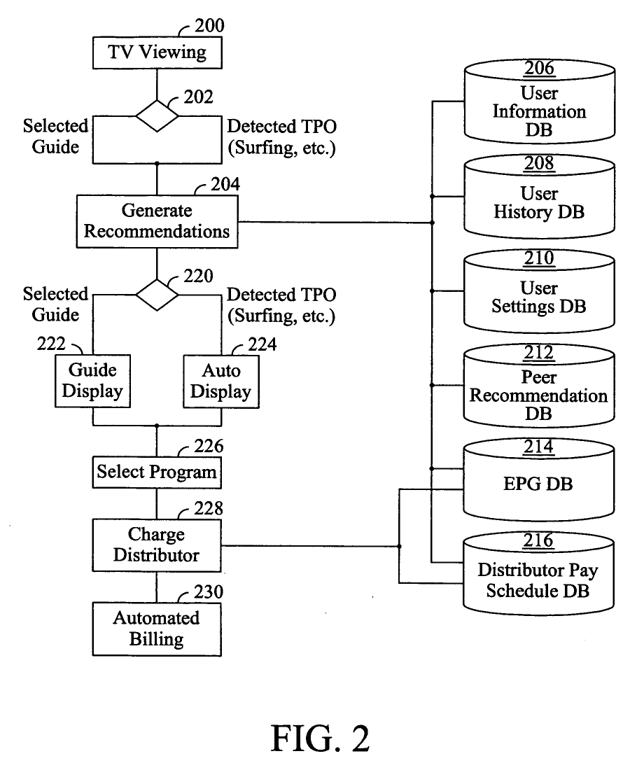

Referring now to FIG. 2, a flowchart showing a timed sequence of events is presented. At block 200, a user views a television and either selects a guide or performs some other programming selection event, such as channel surfing. This event is detected at node 202. At block 204, recommendations are generated based upon information culled from numerous database sets such as the user-information database 206, the user-history database 208, the user-settings database 210, the peer-recommendations database 212, and the general extended-programming database 214. In addition, the distributor-pay-schedule database 216 may be queried for programs containing advertiser bids.

It should be noted that the distributor-pay-schedule database 216 may or may not have programming content in common with the first database set consisting of databases 206, 208, 210, 212 and 214. This is an option that could be provided by the recommendation company that maintains the databases. At block 220, if the user selects a programming guide, the guide is displayed as shown at block 222. However, if surfing has been detected, or some other programming-selection-choice action has been taken by the TV-viewer, the autodisplay function at block 224 displays the recommendations to the viewer based upon the recommendations generated at block 204. The TV-viewer may select a program at block 226 and this selection may result in a charge directed to the advertiser who had placed bids on programs in the distributor-pay-schedule database 216. An automated billing system (block 230) may be provided which debits the advertisers' accounts. In addition, revenue may be generated by charging advertisers who have programs in the extended-programming database 214 but who did not submit bids.

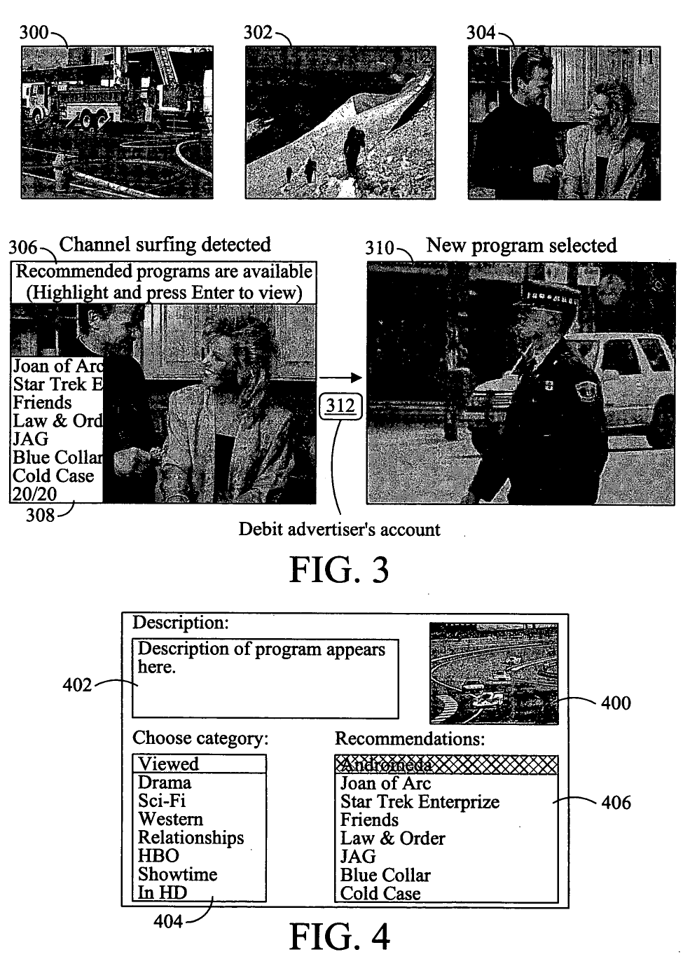

Referring to FIG. 3, a user interface is suggested. As a TV-viewer begins to channel surf (as indicated at illustrations 300, 302 and 304), surfing is detected and a display is provided at illustration 306. A window 308 displays programs currently available or within a predetermined time-window which relate to the program being viewed as pure recommendations from a first set of databases 206-214 and through a distributor-pay-schedule database 216 (refer to FIG. 2). Once a new program is selected (as shown in illustration 310), the advertiser's account is debited (as shown at block 312).

Another type of window is shown in FIG. 4. This window relegates the program being viewed to a relatively small screen size 400 while a program description appears in another window 402. At the same time, a list of categories may be displayed in window 404 and recommendations based upon the program currently being viewed may be displayed in window 406.

The aforementioned method provides a service to the TV-viewer and a way to generate advertising income for a database provider. Numerous variations of the above-described system are possible. For example, the program content indicators may include genre indicators having an increasing level of specificity. For example, programs may be classified under the general genre heading “mystery.” Within the “mystery” category, there could be indicators classifying the program as police drama, legal drama or action thriller. Other parameters that could be used as program content indicators might include the names of specific actors or actresses, MPAA ratings, or the like. Other suitable parameters serving as program content indicators will suggest themselves to those having skill in the art of constructing search engines and algorithms for retrieving such information.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

I claim:

1. A method of providing a TV-viewer with interactive television program selections comprising the steps of:
(a) compiling a first database set of available TV programs and assigning content indicators to said TV programs based upon predetermined content-indicator parameters;
(b) compiling a second database of TV program selections containing bid amounts submitted by advertisers;
(c) detecting the initiation of a programming choice by said TV-viewer and detecting the content of said programming choice according to said content-indicator parameters; and
(d) displaying to said TV-viewer an ordered list of alternative program selections determined by searching at least said first database set and said second database, said alternative program selections from said first database set having program content matching said programming choice by said TV-viewer.

2. The method of claim 1 further including the step of displaying alternative program selections from said second database in said ordered list giving prominence in said list according to said bid amounts.

3. The method of claim 2 further including the step of issuing a debit to said advertiser for said bid amount whenever an alternative programming selection containing said advertiser's bid is displayed in said ordered list.

4. The method of claim 3 further including the step of issuing a second debit to said advertiser whenever said alternative programming selection containing said advertiser's bid is selected as a program choice by said TV-viewer.

5. The method of claim 1 wherein said content-indicator parameters include the genre of said available TV programs.

6. The method of claim 5 wherein said ordered list contains TV-program selections available within a predetermined time that is coincident with the time slot occupied by said programming choice made by said TV-viewer.

7. The method of claim 6 wherein said time span includes the time occupied by said program choice plus one hour.

8. The method of claim 6 wherein said time span comprises the time span of said TV-program choice plus two hours.

9. The method of claim 1 further including in said first database set databases of TV-program selections based upon information supplied by said TV-viewer.

10. The method of claim 9 wherein said first database set includes databases indicating said TV-viewer's personal preferences, program selection history, user settings and peer recommendations.

11. The method of claim 1 wherein the step of detecting the initiation of a programming choice is commenced upon power-up of the television, changing a TV channel or selecting a TV-guide function.

12. The method of claim 2 further including the step of searching said second database for program selections having program-content indicators matching the programming choice detected in step (c).

13. The method of claim 1 wherein step (b) includes the step of classifying TV-program selections in said second database according to content by said content-indicator parameters.

14. The method of claim 13 including the step of searching said second database for TV-program selections related to said programming choice by said content-indicator parameters.
